(19) United States
(12) Patent Application Publication
(10) Pub. No.: US 2024/0190050 A1
(43) Pub. Date: Jun. 13, 2024

(54) HOLLOW COMPOSITE BICYCLE COMPONENT AND METHOD OF MANUFACTURING THE HOLLOW COMPOSITE BICYCLE COMPONENT

(71) Applicant: SRAM, LLC, CHICAGO, IL (US)

(72) Inventors: CHIA CHANG CHANG, TAICHUNG CITY (TW); CHEN HSIUNG CHEN, TAICHUNG CITY (TW); HUAN CHING HSU, TAICHUNG CITY (TW); CHING HAN LIU, TAICHUNG CITY (TW); CHU CHEN WANG, TAICHUNG CITY (TW)

(73) Assignee: SRAM, LLC, CHICAGO, IL (US)

(21) Appl. No.: 18/533,353

(22) Filed: Dec. 8, 2023

Related U.S. Application Data
(60) Provisional application No. 63/431,949, filed on Dec. 12, 2022.
(60) Provisional application No. 63/503,560, filed on May 22, 2023.

(51) Int. Cl. B29C 33/52; B29C 33/38; B29C 70/34; B62M 3/00

(52) U.S. Cl. CPC B29C 33/52; B29C 33/3842; B29C 70/34; B62M 3/00; B29L 2031/3091

(57) ABSTRACT

A bicycle component includes a composite laminate. The composite laminate includes a hollow container made of a first polymer-based material, a layer of a second polymer-based material disposed on the hollow container, and a layer of a composite material disposed on the layer of the second polymer-based material. The bicycle component also includes a water soluble core material disposed within hollow container. The water soluble core material is dissolvable and removable from the composite laminate after lamination of the composite laminate

### PRIORITY

This application claims the benefit of U.S. Provisional Application No. 63/431,949, filed on Dec. 12, 2022, and U.S. Provisional Application No. 63/503,560, filed on May 22, 2023, which are hereby incorporated by reference in their entirety.

### BACKGROUND

### 1. Field of the Disclosure

The present disclosure is generally directed to manufacturing a composite bicycle component, and more particularly, manufacturing a hollow composite bicycle component.

### 2. Description of Related Art

Hollow bicycle components such as, for example, rims, crank arms, and handlebars may be formed of extruded metals or other materials that are bent and bonded into a circular shape having consistently shaped cross sections. Recently, other materials, such as fiber reinforced plastics, have been used in the manufacture of hollow bicycle components, which may be formed into circular shapes through non-extrusion based processes. Carbon fiber reinforced plastics may, for example, be used.

Manufacturing a hollow bicycle component may include molding a foam core prior to the manufacturing of the hollow bicycle component, and then stacking individual sheets of carbon fiber composite material, for example, to form structures of the hollow bicycle component. The carbon fiber composite sheets may be pre-pregnated with a resin (e.g., a thermoplastic resin or a thermosetting resin) or other matrix material that undergoes a curing process to form the hollow bicycle component. The foam core is left within the formed hollow bicycle component.

Application of the thermoplastic resin, which does not have a sticky surface at room temperature, uses extra equipment, such as a double-belt press machine and a hot-press machine, for tape consolidation and laminate production to obtain, for example, carbon fiber reinforced thermoplastic (CFRT) sheets with specific stacking angles of thermoplastic prepregs. Application of the thermosetting resin, which has a sticky surface at room temperature, requires personnel to lay out stacking angles of thermosetting prepregs.

### SUMMARY

In one example, an intermediate product includes a composite laminate. The composite laminate includes a hollow container made of a first polymer-based material, a layer of a second polymer-based material disposed on the hollow container, and a layer of a composite material disposed on the layer of the second polymer-based material. The intermediate product also includes a water soluble core material disposed within the hollow container. The water soluble core material is dissolvable and removable from the composite laminate after lamination of the composite laminate.

In one example, the intermediate product is a crank arm.

In one example, the second polymer-based material is the same as the first polymer-based material. The first polymer-based material and the second polymer-based material are a thermoplastic material.

In one example, the composite material includes a matrix of a third polymer-based material and fibers of a reinforcing material. The third polymer-based material is a thermoplastic, a thermoset matrix, or a combination thereof, and the fibers of the reinforcing material are carbon fibers.

In one example, the intermediate product further includes a preformed connector disposed on the hollow container. The layer of the second polymer-based material and the layer of the composite material are disposed on the preformed connector, such that the preformed connector is integrated within the composite laminate.

In one example, the water soluble core includes salt, expandable microspheres, or salt and expandable microspheres.

In one example, the water soluble core further includes a binder.

In one example, the salt includes sodium chloride, potassium chloride, potassium sulfate, or any combination thereof. The binder includes gum Arabic, ethyl cellulose, sodium silicate, trehalose, starch, polyvinylpyrrolidone, polyethylene glycol, acrylamide, or any combination thereof.

In one example, the hollow container has a first side and a second side opposite the first side. The layer of the second polymer-based material is a first layer of the second polymer-based material, and the layer of the composite material is a first layer of the composite material. The first layer of the second polymer-based material is disposed on the first side of the hollow container. The composite laminate further includes a second layer of the second polymer-based material disposed on the second side of the hollow container, and a second layer of the composite material disposed on the second layer of the second polymer-based material.

In one example, a hollow bicycle component includes a composite laminate. The composite laminate includes a hollow container made of a first polymer-based material, a layer of a second polymer-based material disposed on the hollow container, and a layer of a composite material disposed on the layer of the second polymer-based material. The composite material includes a matrix of a third polymer-based material and fibers of a reinforcing material.

In one example, the composite laminate further includes a first outermost layer configured as a first cover. The first outermost layer is made of a thermoplastic material and is configured to cover at least part of the composite laminate at a first side of the hollow container. The composite laminate further includes a second outermost layer configured as a second cover. The second outermost layer is made of the thermoplastic material and is configured to cover at least a part of the composite laminate at a second side of the hollow container. The second side of the hollow container is opposite the first side of the hollow container.

In one example, the first outermost layer includes at least one first attachment feature, and the second outermost layer includes at least one second attachment feature. The at least one second attachment feature is attachable to the at least one first attachment feature before lamination of the composite laminate, such that the first layer of the second polymer-based material is pressed against the first side of the hollow container and the second layer of the second polymer-based material is pressed against the second side of the hollow container before the lamination.

In one example, the hollow bicycle component includes a connector disposed on the hollow container. The layer of the second polymer-based material and the layer of the composite material are disposed on the connector, such that the connector is integrated within the composite laminate.

In one example, the hollow container has a first side and a second side opposite the first side. The layer of the second polymer-based material is a first layer of the second polymer-based material, and the layer of the composite material is a first layer of the composite material. The first layer of the second polymer-based material is disposed on the first side of the hollow container. The composite laminate further includes a second layer of the second polymer-based material disposed on the second side of the hollow container, and a second layer of the composite material disposed on the second layer of the second polymer-based material.

In one example, the hollow container has a first end and a second end opposite the first end. The first end and the second end extend between the first side and the second side of the hollow container. The connector is a first connector disposed on the first end of the hollow container. The second layer of the second polymer-based material and the second layer of the composite material are disposed on the connector. The first layer of the second polymer-based material, the first layer of the composite material, the second layer of the second polymer-based material, and the second layer of the composite material are disposed on the second connector, such that the second connector is integrated within the composite laminate.

In one example, a method for manufacturing a hollow bicycle component includes forming a hollow container. The hollow container is made of a first polymer-based material. The method also includes preparing a core material mixture. The core material mixture includes a salt, expandable microspheres, or a combination thereof. The method also includes filling the hollow container with the core material mixture and forming a layup pattern. Forming the layup pattern includes positioning at least a layer of a second polymer-based material and a layer of a composite material on the hollow container. The method also includes forming a composite laminate including the hollow container, the layer of the second polymer-based material, and the layer of the composite material, and dissolving, removing, or dissolving and removing the core material mixture.

In one example, preparing the core material mixture includes preparing a powdered mixture and stirring a binder into the powdered mixture, or preparing a salt core and disposing the expandable microspheres on the salt core. Preparing the powdered mixture includes mixing the salt and the expandable microspheres. Preparing the salt core includes mixing the binder and the salt.

In one example, the method also includes positioning a metal connector, such that the metal connector is in contact with the hollow container. The layer of the second polymer-based material and the layer of the composite material are positioned on the hollow container, such that the layer of the second polymer-based material and the layer of the composite material are also positioned on the metal connector. Forming the composite laminate includes forming the composite laminate, such that the metal connector is integrated with the composite laminate.

In one example, the hollow container has a first side and a second side opposite the first side. Positioning at least the layer of the second polymer-based material and the layer of the composite material includes positioning a first outermost layer at the first side of the hollow container, such that a first part of the layup pattern is disposed within a pocket of the first outermost layer, and positioning a second outermost layer at the second side of the hollow container, such that a second part of the layup pattern is disposed within a pocket of the second outermost layer. The method also includes attaching the first outermost layer to the second outermost layer. The attaching includes attaching an attaching feature of the first outermost layer to an attaching feature of the second outermost layer.

In one example, forming the composite laminate comprises hot pressing the composite laminate.

### BRIEF DESCRIPTION OF THE DRAWINGS

Objects, features, and advantages of the present invention will become apparent upon reading the following description in conjunction with the drawing figures, in which:

FIG. 1 is a side view schematic of a bicycle that may be constructed to utilize a hollow composite component;

FIG. 2 is a side view of a wheel for a bicycle, such as the bicycle of FIG. 1;

FIG. 3 is an exploded cross-section of an uncured composite crank arm formed with a salt-based core material and layers of composite material;

FIG. 4 is a flow chart of an embodiment of a method for manufacturing a hollow composite bicycle component;

FIG. 5 illustrates a first embodiment of a salt-based core for manufacturing a hollow composite bicycle component;

FIG. 6 illustrates a second embodiment of a salt-based core for manufacturing a hollow composite bicycle component;

FIG. 7 is an exploded cross-section of an uncured composite crank arm formed with a salt-based core material, layers of composite material, and thermoplastic sheets with interlocking features;

FIG. 8 is a top view of a first thermoplastic sheet of the thermoplastic sheets with interlocking features of FIG. 7;

FIG. 9 is a top view of a second thermoplastic sheet of the thermoplastic sheets with interlocking features of FIG. 7;

FIG. 10a illustrates an interlocking feature of the first thermoplastic sheet of FIG. 8 and an interlocking feature of the second thermoplastic sheet of FIG. 9 before engagement; and

FIG. 10b illustrates the interlocking features of FIG. 10a engaged.

### DETAILED DESCRIPTION OF THE DISCLOSURE

The use of sheets or strips of carbon fiber to manufacture a composite bicycle component of the prior art provides a number of advantages compared to traditional components formed of extruded metals or other materials. For example, carbon fiber based bicycle components have a high tensile strength, a low weight, a high temperature tolerance, and a low thermal expansion compared to traditional bicycle components formed of extruded metals or other materials.

A hollow composite bicycle component (e.g., a rim or a crank arm) may be manufactured using a foam core that provides support during the curing process. The foam core remains within the finished component, which adds weight to the finished component. Further, the foam core itself is manufactured by, for example, molding and further processing. This adds time, cost, and complexity to the manufacturing process for the hollow composite bicycle component.

A core material of the present disclosure is simple to produce, is low-cost, and provides an internal pressure during molding of a resin shell, so that a structure of a hollow composite (e.g., carbon fiber composite) bicycle component has high performance with respect to mechanical properties. For example, a core material of the present disclosure may maintain an existing shape at 260° C. or higher without softening. Further, a core material of the present disclosure may be easily removed from a finished hollow composite bicycle component after molding.

A core material of the present disclosure may include salt, a binder, and expandable beads. Such a core material has a high temperature resistance and a high pressure resistance. The expandable beads provide internal pressure during hot pressing. The core material is water-soluble and is environmentally friendly.

A container that holds a core material of the present disclosure may be made from a same resin material (e.g., bendable fabric preform sheets) as a composite material of which the hollow composite bicycle component is made. Such a resin material may be characterized by a film (e.g., shell) structure and may be formed to an appropriate shape according to requirements of a design of the hollow composite bicycle component. Such a container may be formed to complex geometries, and during hot pressing (e.g., forming) of the composite material of the hollow composite bicycle component, the container becomes engaged with laminating and is joined into a structure of the composite material.

A method of manufacturing a core for manufacturing a hollow composite bicycle component includes forming a container, mixing a core material, and disposing the mixed core material within the formed container. The container may be made of a resin material (e.g., bendable fabric preform sheets) and may be formed to a shape according to a design of the hollow composite bicycle component to be manufactured. The mixing of the core material may be performed at room temperature and may include mixing the expandable beads and the salt to obtain a powdery mixture. The binder may be added to this powdery mixture (e.g., including the expandable beds and the salt), and the binder may be mixed into the powdery mixture to form the core material. A solution (e.g., water) may be added to (e.g., mixed into) the core material to obtain a particular density and allow the core material to be filled (e.g., poured) into the formed container.

In one embodiment, an optional act of the method includes drying the core material within the formed container. The drying may be performed with a heater (e.g., an oven) for any number of different times depending on a temperature of the heater applied. The drying may reduce the weight percentage of the solution (e.g., water) within the core material. The drying may, for example, solidify and fix a form of the core material within the formed container.

A method of manufacturing a hollow composite bicycle component may include, initially, the act(s) of the method of manufacturing the core and additional acts. For example, the method may also include laminating fabric sheets onto the manufactured core, hot forming the laminated fabric sheets, dissolving at least part of the manufactured core, and cleaning the manufactured core out of the hollow composite bicycle component. The method may include more, fewer, and/or different acts.

The laminating of the fabric sheets onto the manufactured core may include positioning a thermoplastic material (e.g., layers of thermoplastic resin) within a layup pattern before hot forming the laminated fabric sheets. Application of a layer of thermoplastic resin, which does not have a sticky surface at room temperature, may require extra equipment for, for example, tape consolidation (e.g., a double-belt press) and laminate production (e.g., a hot-press machine) to obtain, for example, carbon fiber reinforced thermoplastic (CFRTP) sheets with specific stacking angles of thermoplastic prepregs. Alternatively or additionally, the laminating of the fabric sheets onto the manufactured core may include positioning another thermoplastic material (e.g., layers of thermosetting resin) within the layup pattern before hot forming the laminated fabric sheets. Application of a layer of thermosetting resin, which is an epoxy with a sticky surface at room temperature, may require personnel to lay out appropriate stacking angles of thermosetting prepregs.

An interlocking mechanism of the present embodiments sets each CFRTP (e.g., collectively, the layup pattern), for example, prior to hot forming the laminated fabric sheets. Use of the interlocking mechanism of the present embodiments may save time and money in the production of a component (e.g., the hollow composite bicycle component), in that manufacturing processes such as, for example, tape consolidation and laminate production may be skipped, and expensive equipment such as, for example, a double-belt press may not be necessary. Further, the number of personnel necessary for manufacturing may be reduced.

The interlocking mechanism of the present embodiments may be made of a resin material (e.g., a thermoplastic resin or a thermosetting resin) and may form one or more outermost layers of the layup pattern. For example, the one or more outermost layers may include outermost layers at a top, a bottom, a right side, a left side, a front, and/or a rear of the layup pattern.

A first outermost layer of the interlocking mechanism includes at least one first extended structure (e.g., at least one first interlocking feature; square in shape), and a second outermost layer of the interlocking mechanism includes at least one second extended structure (e.g., at least one second interlocking feature; circular in shape). The first outermost layer and the second outermost layer are on opposite sides of the layup pattern. The at least one first extended structure and the at least one second extended structure may be any number of sizes. For example, a diameter of a circular cross-section of a second extended structure of the at least one second extended structure may be equal to a length of a side of a square cross-section of a first extended structure of the at least one first extended structure. Heights of the at least one first extended structure and the at least one second extended structure, respectively, may be the same. Other shapes and size may be provided.

1 Before latching the interlocking mechanism (e.g., latching corresponding interlocking features on the first outermost layer and the second outermost layer, respectively), multiple single layer CFRTP prepregs (e.g., the layup pattern) are positioned within a volume defined by (e.g., enclosed by) opposite outermost layers (e.g., the first outermost layer and the second outermost layer forming at least part of the interlocking mechanism). One or more sides of the first outermost layer are pivoted towards the layup pattern, such that the at least one first interlocking feature is also pivoted towards the layup pattern; one or more sides of the second outermost layer are pivoted towards the layup pattern, such that the at least one second interlocking feature is also pivoted towards the layup pattern. The one or more sides of the first outermost layer and the one or more sides of the second outermost layer are pivoted towards the layup pattern until the at least one first interlocking feature engages with the at least one second interlocking feature, respectively. The at least one first interlocking feature engages with the at least one second interlocking feature, respectively, by one interlocking feature (e.g., a second interlocking feature, circular in shape) on one of the first outermost layer and the second outermost layer moving into the other interlocking feature (e.g., a first interlocking feature, square in shape) on the other of the first outermost layer and the second outermost layer.

The first outermost layer and the second outermost layer, for example, may be sized, and the at least one first interlocking feature and the at least one second interlocking feature may be positioned on the first outermost layer and the second outermost layer, respectively, such that when the at least one first interlocking feature and the at least one second interlocking feature engage with each other, respectively, layers within the layup pattern are pressed against the hollow container and set. A pre-laminated CFRTP may then be subjected to final press molding, for example, and the hollow composite bicycle component may be obtained.

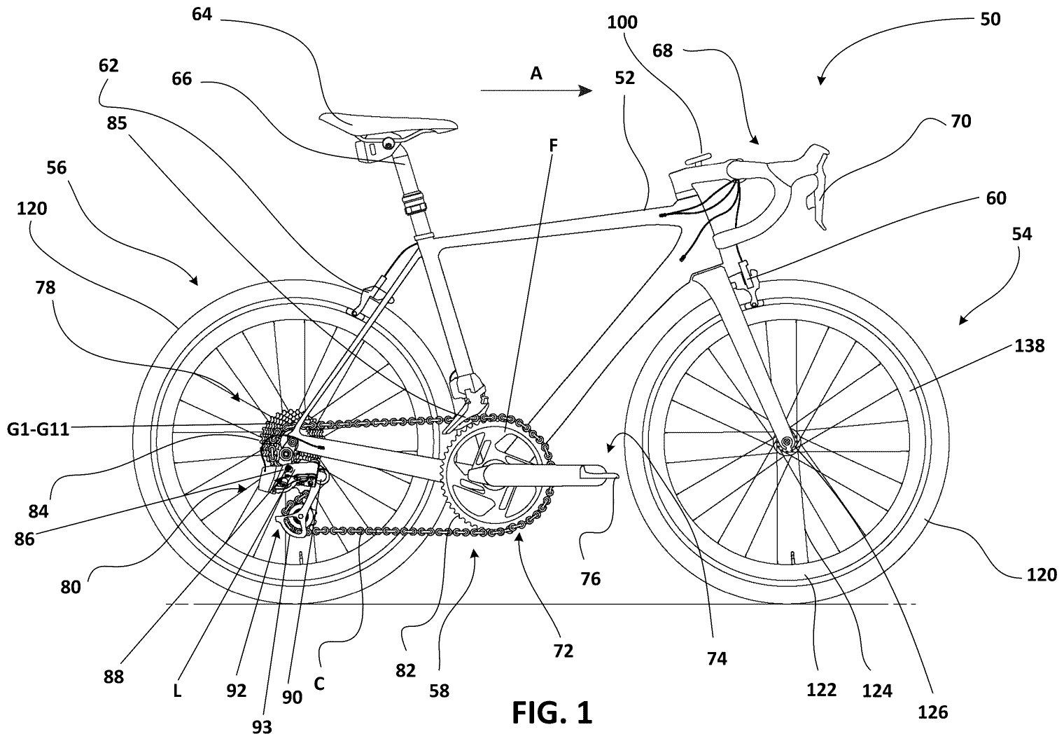

Turning now to the drawings, FIG. 1 generally illustrates a bicycle 50 that employs one or more components (e.g., rims, crank arms) constructed in accordance with the teachings of the present disclosure. The bicycle 50 includes a frame 52, a front wheel 54 and a rear wheel 56 each rotatably attached to the frame 52, and a drivetrain 58. A front brake 60 is provided for braking the front wheel 54, and a rear brake 62 is provided for braking the rear wheel 56. The bicycle 50 also generally has a seat 64 near a rear end of the frame 52 and carried on an end of a seat post 66 connected to the frame 52. The bicycle 50 also has handlebars 68 near a forward end of the frame 52. A brake lever 70 is carried on the handlebars 68 for actuating the front brake 60, the rear brake 62, or both the front brake 60 and the rear brake 62. If the brake lever 70 actuates only one of the front brake 60 and the rear brake 62, a second brake lever (not shown) may also be provided to actuate the other brake. A front and/or forward riding direction or orientation of the bicycle 50 is indicated by the direction of the arrow A in FIG. 1. As such, a forward direction for the bicycle 50 is indicated by the direction of arrow A. While the illustrated bicycle 50 depicted in FIG. 1 is a road bike having drop-style handlebars 68, the present disclosure may be applicable to bicycles of any type, including mountain bikes with full or partial suspensions.

The drivetrain 58 has a chain C and a front sprocket assembly 72, which is coaxially mounted with a crank assembly 74 (e.g., including two crank arms) having pedals 76. The drivetrain 58 also includes a rear sprocket assembly 78 coaxially mounted with the rear wheel 56 and a rear gear change mechanism, such as a rear derailleur 80.

As is illustrated in FIG. 1, the front sprocket assembly 72 may include one or more coaxially mounted chainrings, gears, or sprockets. In this example, the front sprocket assembly 72 has one sprocket F. The one sprocket F has teeth 82 around a respective circumference. As shown in FIG. 1, the rear sprocket assembly 78 may include a plurality of coaxially mounted gears, cogs, or sprockets G. Each sprocket G1-G11 also has teeth 84 arranged around a respective circumference. The number of teeth 84 on the rear sprockets G1-G11 may gradually decrease from the largest diameter rear sprocket G1 to the smallest diameter sprocket G11. Though not described in any detail herein, a front gear changer 85 may be operated to move from a first operating position to a second operating position to move the chain C between front sprockets F. Likewise, the rear derailleur 80 may be operable to move between different operating positions to switch the chain C to a selected one of the rear sprockets G1-G11. In an embodiment, the rear sprocket assembly 78 may have more or fewer sprockets G. For example, in an embodiment, the rear sprocket assembly 78 may have twelve or thirteen sprockets. Dimensions and configuration of the rear derailleur 80 may be modified to accommodate a specific implemented plurality of sprockets. For example, an angle and length of the linkage and/or the configuration of the cage of the derailleur may be modified to accommodate specific sprocket combinations.

The rear derailleur 80 is depicted as a wireless, electrically actuated rear derailleur mounted or mountable to the frame 52, or frame attachment, of the bicycle 50. The electric rear derailleur 80 has a base member 86 (e.g., a b-knuckle) that is mounted to the bicycle frame 52. A linkage 88 has two links L that are pivotally connected to the base member 86 at a base member linkage connection portion. A movable member 90 (e.g., a p-knuckle) is connected to the linkage 88 at a moveable member linkage connection portion. A chain guide assembly 92 (e.g., a cage) is configured to engage and maintain tension in the chain and has one or more cage plates 93 with a proximal end that is pivotally connected to a part of the movable member 90. The cage plate 93 may rotate or pivot about a cage rotation axis in a damping direction and a chain tensioning direction. Other gear changing systems, such as mechanically or hydraulically controlled and/or actuated systems may also be used.

A motor module may be carried on the electric rear derailleur 80 with a battery. The battery supplies power to the motor module. In one example, the motor module is located in the movable member 90. However, the motor module may instead be located elsewhere, such as in one of the links L of the linkage 88 or in the base member 86. The motor module may include a gear mechanism or transmission. As is known in the art, the motor module and gear mechanism may be coupled with the linkage 88 to laterally move the cage plate 93 and thus switch the chain C among the rear sprockets (e.g., G1-G11) on the rear sprocket assembly 78.

The cage plate 93 also has a distal end that carries a tensioner cog or wheel. The wheel also has teeth around a circumference. The cage plate 93 is biased in a chain tensioning direction to maintain tension in the chain C. The chain guide assembly 92 may also include a second cog or wheel, such as a guide wheel disposed nearer the proximal end of the cage plate 93 and the movable member 90. In operation, the chain C is routed around one of the rear sprockets (e.g., G1-G11). An upper segment of the chain C extends forward to the front sprocket assembly 72 and is routed around the one front sprocket F. A lower segment of the chain C returns from the front sprocket assembly 72 to the tensioner wheel and is then routed forward to the guide wheel. The guide wheel directs the chain C to the rear sprockets (e.g., G1-G11). Lateral movement of the cage plate 93, the tensioner wheel, and the guide wheel may determine the lateral position of the chain C for alignment with a selected one of the rear sprockets (e.g., G1-G11).

The bicycle 50 may include one or more bicycle control devices 100 mounted to handlebars 68. The bicycle control devices 100 may include one or more types of bicycle control and/or actuation systems. For example, the bicycle control devices 100 may include brake actuation systems to control the front brake 60 and/or the rear brake 62, and/or gear shifting systems to control the drivetrain 58. Other control systems may also be included. For example, the system may be applied, in some embodiments, to a bicycle where only a front or only a rear gear changer is used. Also, the one or more bicycle control devices may also include suspension, seat post, and/or other control systems for the bicycle 50.

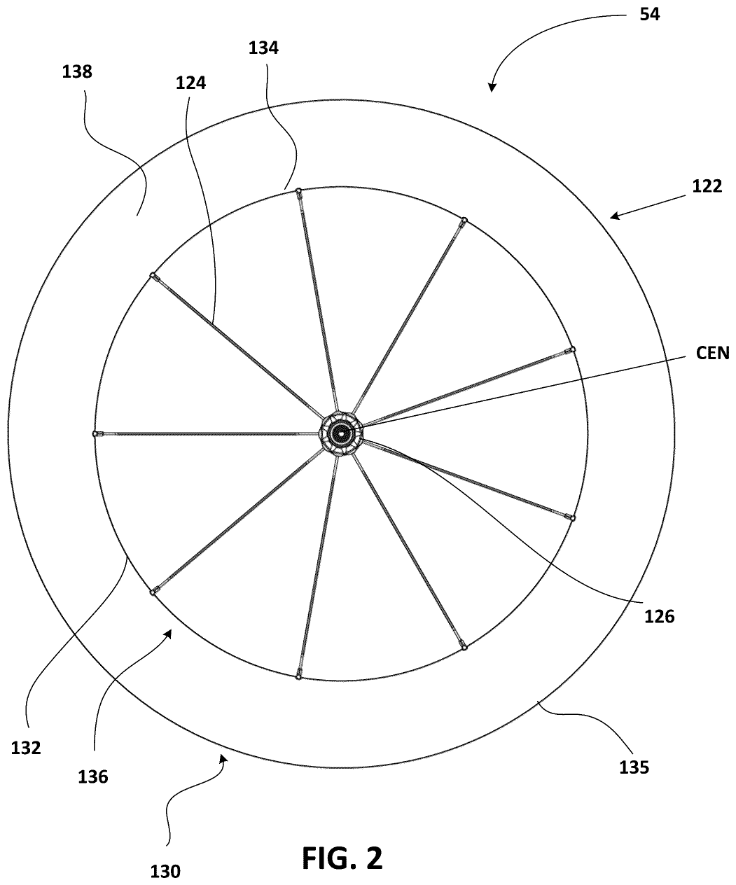

The front wheel 54 and/or the rear wheel 56 of the bicycle 50 may include a tire 120 attached to a radially outer tire engaging portion of a rim 122. As shown in FIGS. 1 and 2, a plurality of spokes 124 are attached directly to the rim 122. Alternatively, the spokes 124 may be attached and/or secured to the rim 122 with other structural components. The spokes 124 extend from the rim 122 and attach to a central hub 126. The spokes 124 are maintained with a tension between the rim 122 and the central hub 126 to provide the respective wheel 54, 56 with an operational rigidity for use on the bicycle 50. The central hub 126 is configured for rotational attachment to the bicycle frame 52.

FIG. 2 illustrates a bicycle wheel having a rim 122, spokes 124, and a central hub 126, such as the front wheel 54 of FIG. 1, removed from the rest of the bicycle 50 and without a tire attached. The rim 122 includes a tire engaging portion 130 to engage with the tire 120, as is shown in FIG. 1. The tire engaging portion 130 is configured radially outward of a spoke receiving surface 132 that is disposed along an inner circumference 134 of the rim 122. In other words, the tire engaging portion 130 is a radially outer tire engaging portion. In an embodiment, the tire engaging portion 130 is disposed along an outer circumference 135 of the rim 122. The tire engaging portion 130 is configured for attachment to tires using clincher tire attachment configurations for tires including beaded interlock attachments. Other configurations of the tire engaging portion 130 may also be provided to allow for the use of other types of tires on the rim 122. For example, tubeless tires including beaded interlock attachment types may be used.

The rim 122 provides structure for attachment of the spokes 124 to the rim 122 at a receiving portion of the rim 122, proximate to the spoke receiving surface 132. As such, the spoke receiving surface 132 is part of a spoke engaging portion 136 (e.g., a radially inner portion) of the rim 122. In an embodiment, the spoke engaging portion 136 of the rim 122 is disposed along the inner circumference 134 of the rim 122. In another embodiment, the spoke receiving surface 132 and the spoke engaging portion 136 may be separate parts and/or portions of the rim 122. For example, the spokes 124 may pass through the spoke receiving surface 132, and the structure for attachment to the rim 122 may be provided proximate to the tire engaging portion 130.

The rim 122 includes a first sidewall 138 and a second sidewall (not shown) that extend between the tire engaging portion 130 and the spoke engaging portion 136. For example, the first sidewall 138 and the second sidewall extend radially outward from the spoke engaging portion 136 to the tire engaging portion 130. The first sidewall 138 is spaced apart from the second sidewall. The rim 122 may be hollow between, for example, the first sidewall 138, the second sidewall, the tire engaging portion 130, and the spoke engaging portion 136

At least part of the rim 122 (e.g., the first sidewall 138 and the second sidewall) is formed by one or more composite materials. In one embodiment, the entire rim 122 is formed by one or more composite materials. In one example, fiber reinforced plastic forms a one-piece unitary rim of a collection of layers including the tire engaging portion 130, the first sidewall 138, the second sidewall, and the spoke engaging portion 136. Other configurations may also be provided. For example, a combination of plastic and carbon-fiber reinforced plastic forms a one-piece unitary rim of a collection of plastic layers and carbon-fiber layers including the tire engaging portion 130, the first sidewall 138, the second sidewall, and the spoke engaging portion 136. Other configurations may also be provided.

The front wheel 54 and the rear wheel 56 may include rims 122 configured for any size wheel. In an embodiment, the rims 122 are configured for use in wheels conforming to a 700C (e.g., a 622 millimeter diameter clincher and/or International Standards Organization 622 mm) bicycle wheel standard.

The front wheel 54 and the rear wheel 56 may rotate about the central hub 126 in either direction. For example, as shown in FIG. 2, the front wheel 54 and the rear wheel 56 may be configured to rotate in a particular rotational direction about the central hub 126. In another example, the front wheel 54 and the rear wheel 56 may be configured to rotate in a direction opposite the particular rotational direction.

In one embodiment, the first sidewall 138, the second sidewall, the spoke engaging portion 136, and the tire engaging portion 130 of the front wheel 54 and/or the rear wheel 56 of the bicycle 50 (e.g., the front wheel 54 and the rear wheel 56 in the example of FIG. 1) are at least partially formed by one or more layers of the one or more composite materials (e.g., layers of composite materials). Each of the one or more layers may include one or more fabric plies (e.g., pieces) of the respective composite material. Different layers of different composite materials may include different numbers of plies or pieces of the composite materials, respectively. At least some of the layers of composite material may be of different shapes and/or sizes. Alternatively, all of the layers of the composite material may be a same shape and/or size.

In one embodiment, at least some of the layers of composite material are shaped as strips. For example, strips of the one or more composite materials may form the first sidewall 138 and the second sidewall of the front wheel 54. The strips of the one or more composite materials may be disposed about the central hub 126 of the front wheel 54, respectively, and the central hub 126 of the rear wheel 56, respectively, to form the first sidewall 138 and the second sidewall of the front wheel 54 and the rear wheel 56, respectively.

In a manufacturing process, the layers of the front wheel 54 and the rear wheel 56, respectively, are integrated with the spoke engaging portion 136 and the tire engaging portion 130 (e.g., layers of composite material forming the spoke engaging portion 136 and the tire engaging portion 130) of the respective wheel 54, 56 by, for example, a curing process, such that a one-piece unitary rim 122 is formed. The rims 122 of the front wheel 54 and rear wheel 56, respectively, may be formed with other manufacturing processes.

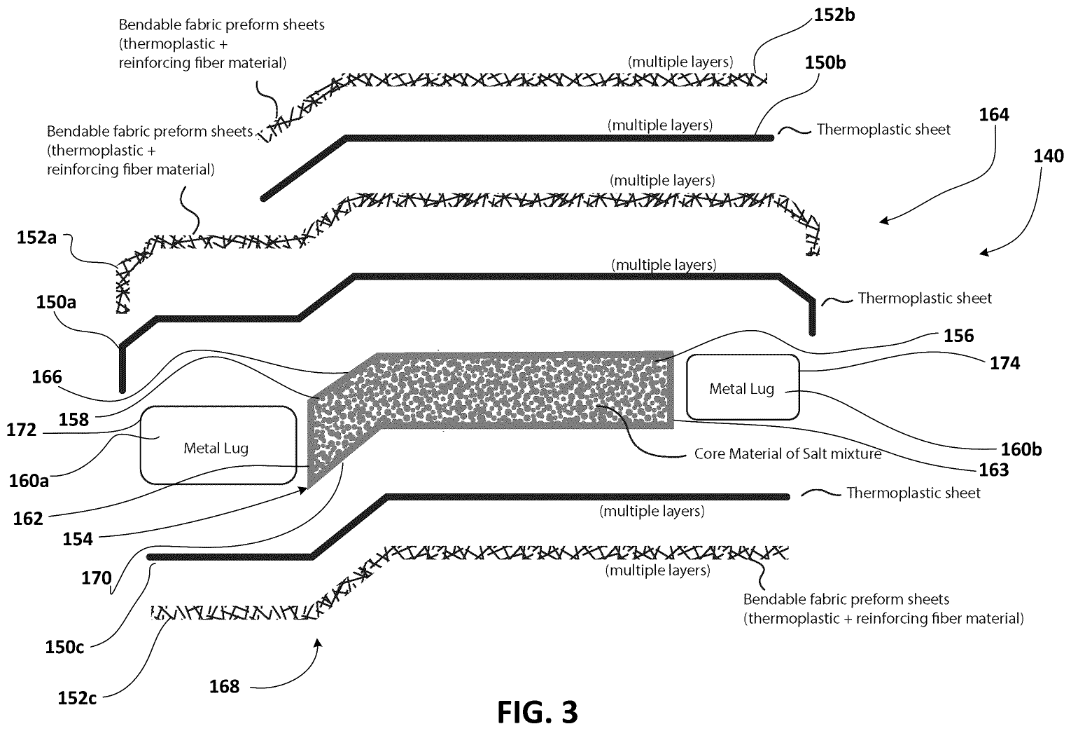

Part of each of the rims 122 is hollow and may be manufactured using a core of the present disclosure. Other hollow bicycle components such as, for example, crank arms may be manufactured similarly. FIG. 3 illustrates one embodiment of a layup pattern of layers (e.g., first layers 150 and second layers 152) of material(s) for a crank arm 140 prior to the curing process. The first layers 150 and the second layers 152, for example, after the curing process, may be part of a one-piece unitary crank arm 140. The resultant one-piece crank arm 140 may be at least partially formed by a laminate that includes one or more compressed layers of one or more materials. Any number of materials may be included within the laminate including, for example, a thermoplastic and/or a thermoplastic with reinforcing fiber material (e.g., bendable fabric preform sheets). The reinforcing fiber material may be any number of reinforcing materials including, for example, carbon. More, fewer, and/or different materials may be included within the laminate.

In one embodiment, the first layers 150 may be thermoplastic sheets, and the second layers 152 may be bendable fabric preform sheets (e.g., a thermoplastic with a reinforcing fiber material). The first layers 150 may be made of any number of different thermoplastics including, for example, acrylic, polyester, polypropylene, polystyrene, Nylon and Teflon. In one embodiment, one or more of the first layers 150 include one or more thermosetting resins. The one or more thermosetting resins may include any number of different thermosetting resins including, for example, epoxy. The second layers 152 may include any number of different reinforcing fiber materials including, for example, carbon fiber or Nylon. Each of the first layers 150 may include a plurality of stacked first sheets, and each of the second layers 152 may include a plurality of stacked second sheets.

Referring to FIG. 3, the layup pattern may include a container 154 (e.g., a thermoplastic sheet container) that houses a core material 156. The layup pattern including the container 154 and housing the core material 156 may form an intermediate product. The core material 156 may be any number of mixtures of materials including, for example, a salt mixture. Thermoplastic sheets 158 of the container 154, for example, are bendable/formable, such that a shape of the container 154 corresponds to a shape of the bicycle component (e.g., the crank arm 140) to be manufactured according to a design.

The core material 156 may be inserted (e.g., poured) into the container 154. Other parts made of materials different than the core material 156 may also be inserted into the container 154. For example, as shown in the embodiment of FIG. 3, metal lugs 160a, 160b (e.g., preformed connectors) may be inserted into (e.g., positioned adjacent to) the container 154 on opposite ends 162, 163 of the container 154, respectively. The metal lugs 160a, 160b may be, for example, locations where the crank arm 140 is attached to other parts of the bicycle. For example, the lugs 160 may include threaded through-holes, and a pedal and a crank shaft of the bicycle may be attached to the crank arm 140 via the threaded through-holes through the lugs 160a, 160b, respectively. The lugs 160a, 160b may be the same or may be different (e.g., may be different sizes and/or shapes, and/or may include different connectors). More, fewer, and/or different (e.g., made of different materials) parts may be included within the container 154 with the core material 156.

The layup pattern includes a first layup pattern 164 on a first side 166 of the container 154 and a second layup pattern 168 on a second side 170 of the container 154. The first side 166 of the container 154 may be opposite the second side 170 of the container 154. The first layup pattern 164 includes alternating first layers 150 and second layers 152. For example, the first layup pattern 164 includes a first layer 150a disposed on the container 154 and the metal lugs 160a, 160b, for example, a second layer 152a disposed on the first layer 150a, a first layer 150b disposed on the second layer 152a, and a second layer 152b disposed on the first layer 150b. The first layup pattern 164 may include more, fewer, and/or different first layers 150, second layers 152, and/or other layers.

In one embodiment, at least some layers of the layup pattern may cover opposite ends of preformed components (e.g., the metal lugs 160a, 160b), respectively, to be integrated with the layup pattern. As shown in the example of FIG. 3, different layers of the first layup pattern 164 may have different sizes and/or shapes. For example, the first layer 150a and the second layer 152a cover opposite ends 172, 174 of the metal lugs 160a, 160b, respectively, while the first layer 150b and the second layer 152b are straighter, do not cover the opposite ends 172, 174 of the metal lugs 160a, 160b, respectively, and are shorter than the first layer 150a and the second layer 152a, respectively. Different sizes and/or shapes of the layers 150, the layers 152, and/or other layers may be provided according to a design of the bicycle component to be manufactured.

The second layup pattern 168 includes a first layer 150c disposed on the second side 170 of the container 154 and the metal lugs 160a, 160b, for example, and a second layer 152c disposed on the first layer 150c. The second layup pattern 168 may include more, fewer, and/or different first layers 150, second layers 152, and/or other layers.

The first layer 150c and the second layer 152c do not cover the opposite ends 172, 174 of the metal lugs 160a, 160b, respectively. The layers of the second layup pattern 168 (e.g., the first layer 150c and the second layer 152c) may have different sizes and/or shapes compared to the layers of the first layup pattern 164. For example, the first layer 150c and the second layer 152c may be longer than the first layer 150b and the second layer 152b, respectively, but may not cover the opposite ends 172, 174 of the metal lugs 160a, 160b, respectively, like the first layer 150a and the second layer 152a. The first layer 150a and the second layer 152a may, however, overlap with the first layer 150c and the second layer 152c. Other configurations (e.g., shapes, sizes, materials, and/or number of layers) may be provided. For example, the second layup pattern 168 may include one or more additional first layers 150 and/or second layers 152. In the embodiment shown in FIG. 3, the second layup pattern 168 is thinner (e.g., includes fewer first layers 150 and second layers 152 and/or includes fewer sheets) than the first layup pattern 164. In one embodiment, the second layup pattern 168 is as thick as or thicker than the first layup pattern 164.

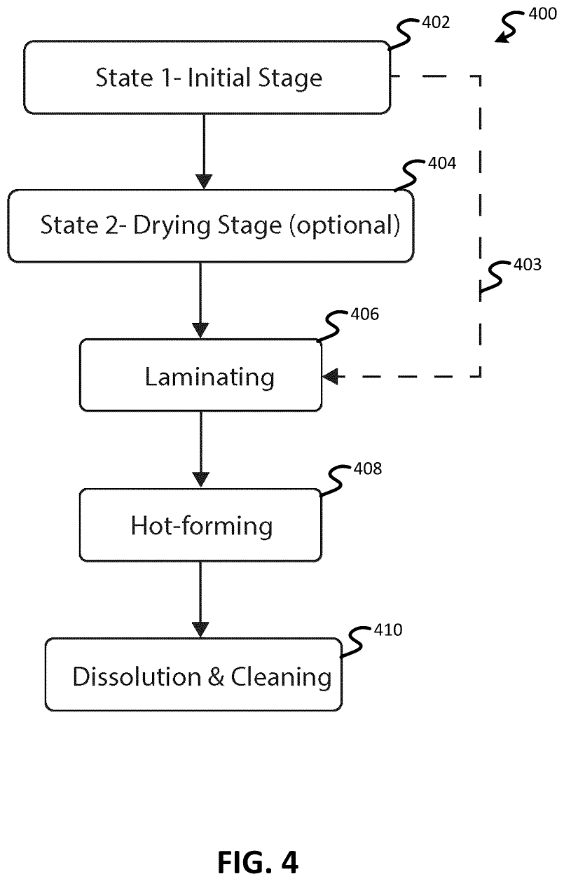

The core material 156 and ultimately the composite bicycle component (e.g., the crank arm 140) may be manufactured in any number of ways. For example, FIG. 4 illustrates a method 400 for manufacturing a bicycle component (e.g., the rim 122 or the crank arm 140) of a bicycle (e.g., the bicycle 50). The acts of the method 400 presented below are intended to be illustrative. In some embodiments, the method 400 may be accomplished with one or more additional acts not described, and/or without one or more of the acts discussed. Additionally, the order in which the acts of the method 400 are illustrated in FIG. 4 and described below is not intended to be limiting.

In act 402, a material mixture (e.g., a salt mixture) for a core (e.g., the core material 156) is produced. The salt mixture, for example, may include any number of components. For example, the salt mixture may include one or more binders (e.g., a binder), one or more salts (e.g., a salt), and one or more different types of expandable beads (e.g., expandable microspheres). The material mixture may include more, fewer, and/or different components. For example, the material mixture may include a binder and expandable beads, but not include a salt. In another example, the material mixture may include a salt and a binder, but not expandable beads.

The binder may be any number of different types of binders including, for example, a water-soluble compound with binding ability. For example, the binder may be gum Arabic, ethyl cellulose, sodium silicate, trehalose, starch, polyvinylpyrrolidone, polyethylene glycol, acrylamide, pyrodextrin, and/or another binder. The salt mixture may include two or more different binders.

The salt may be any number of different types of salts including, for example, a neutral salt soluble in water. For example, the salt may be sodium chloride, potassium chloride, magnesium chloride, sodium carbonate, potassium bromide, potassium sulfate, and/or another salt. The salt mixture may include two or more different salts.

The expandable beads may be any number of different types of expandable materials including, for example, a thermoplastic polymer that undergoes expansion. For example, the expandable beads may be expandable microspheres sold by Kurcha or AkZoNobel under the brand names Kureha Microspheres or Expancel®. Expancel® microspheres, for example, are a lightweight filler and blowing agent. The thermoplastic microspheres encapsulate a gas. With added heat, the gas within thermoplastic shells of the microspheres expands, the thermoplastic shells soften, and volumes of the microspheres respectively expand.

The salt mixture for the core may be mixed under any number of conditions including, for example, at room temperature. In one embodiment, a first mixture is produced by mixing the expandable beads and the salt uniformly with predetermined portions, respectively. The first mixture is, for example, a powdered mixture. A second mixture is then produced by adding the binder to the first mixture and mixing (e.g., stirring) the binder into the first mixture. In one embodiment, a solution may be added to and mixed (e.g., stirred) into the second mixture to obtain a desired density (e.g., a predetermined density) of the salt mixture, such that a container (e.g., defining a shape of the component to be manufactured; a shell container) may be filled. For example, the solution may be water, and the water may be stirred into the second mixture to obtain the desired density of the salt mixture.

In act 404, the salt mixture produced in act 402 may be dried. Act 404 may be optional, in that the method 400 may move directly to act 406 after act 402 has been performed (see arrow 403). When, however, act 404 is performed, the salt mixture may be dried in any number of different ways. For example, heat may be applied to the salt mixture to dry the salt mixture. In one embodiment, the salt mixture is dried using an oven. The drying may be at a low temperature (e.g., 100° C.) or a high temperature (e.g., 200 C) for a shorter period of time compared to drying at the low temperature. The drying process may reduce the solution (e.g., water) within the salt mixture, such that a lower weight percentage of the solution within the salt mixture is provided (e.g., after evaporation of water within the salt mixture).

A container (e.g., the container 154) may be produced according to a design of the composite bicycle component to be manufactured. The container may be made of a thermoplastic resin material (e.g., bendable fabric preform sheets) that is formable to a shape according to the design of the composite bicycle component to be manufactured. The drying temperature in act 404 may be less than a softening temperature of the thermoplastic resin used for the container. The container may be filled with the salt mixture (e.g., the salt mixture may be poured into the container), and the salt mixture may be dried within the container, such that the salt core is formed within the container. In other words, a form of the salt core (e.g., a core form) is fixed within the container during the drying process.

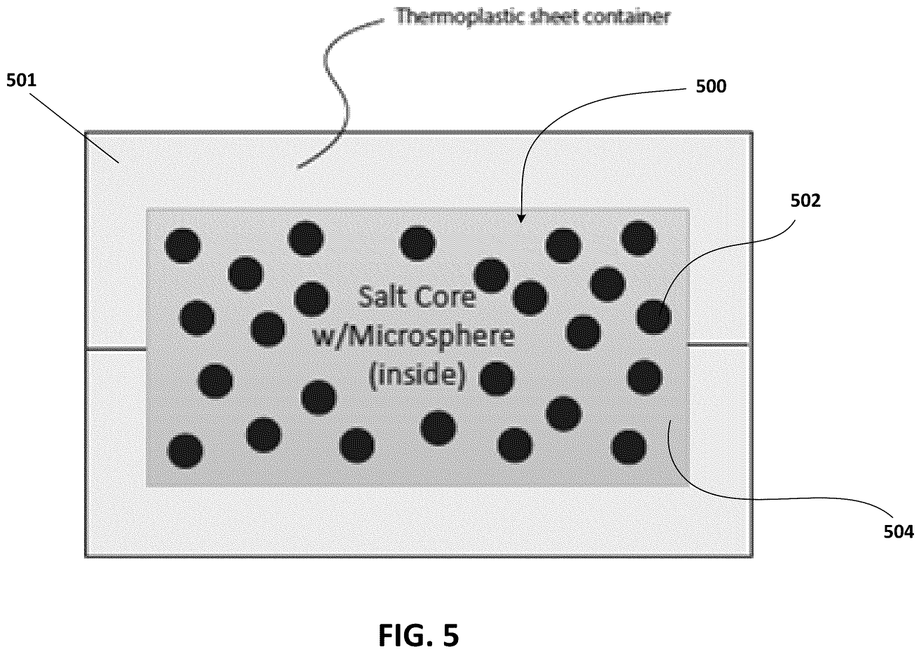

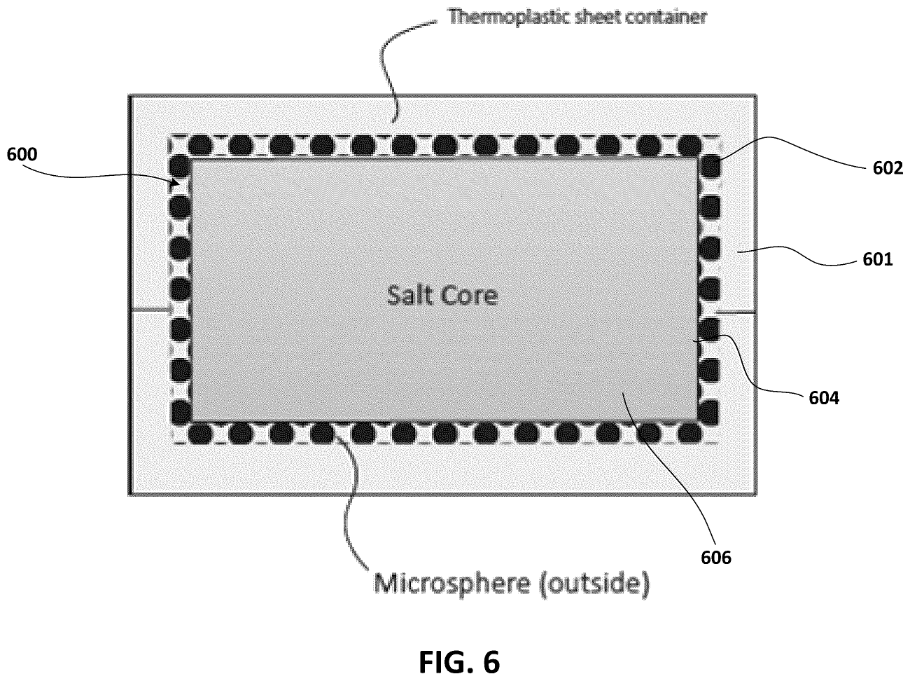

FIGS. 5 and 6 show two embodiments of a material mixture disposed within a thermoplastic sheet container. FIG. 5 shows a first embodiment of a material mixture 500 within a container 501. The material mixture 500 includes expandable beads 502 mixed into a salt mixture 504 (e.g., including a salt and a binder), as described above. The material mixture 500 is, for example, a powdered mixture of the salt, the binder, and the expandable beads 502. As an example, such a material mixture 500 includes, before drying in act 404, 68.40% weight percentage salt, 7.60% weight percentage expandable beads 502, 8.00% weight percentage binder, and 16.00% weight percentage water. Other weight percentages may be provided. For example, a salt mixture may include 50.0%-80.0% weight percentage salt, 5.0%-20.0% weight percentage expandable beads, 4.0%-15% weight percentage binder, and 5%-25% weight percentage water.

Such a material mixture 500 includes, after drying in act 404, 85.50% weight percentage salt, 9.5% weight percentage expandable beads 502, and 5.00% weight percentage binder, with the water fully evaporated. The weight ratio of the salt to the expandable beads 502 may be nine to one. Different ratios of salt to expandable beads 502 may be provided after the drying in act 404. For example, ratios of salt to expandable beads 502 of ten to one, eight to one, seven to one, or five to one may be provided. Other ratios of salt to expandable beads may be provided.

Table 1 below shows different examples of core material mixtures, including weight percentage ranges for salt, a binder, and expandable beads (e.g., expandable microspheres), respectively, for different types of cores (e.g., for the core material 156).

TABLE 1

| | | Weight Ratio of Composition | | |
|---|---|---|---|---|
| | | | | Expandable |
| Core Type | | Mineral Salt | Binder | Microspheres |
| C1 | Expandable Core | 0% | 0-40% | 60-100% |
| C2 | Expandable Salt Core | 15-70% | 10-35% | 7-50% |
| C3 | Hard Salt Core | 70-100% | 0-30% | 0% |

| | | |
|---|---|---|
| C4 | Composite Salt Core | C3 core base, covered with expandable |
| | | microsphere layer, weight ratio 0-0.5 g/cm² |

As shown in Table 1, Core Type C1 represents an expandable core, C2 represents an expandable salt core, C3 represents a hard salt core, and C4 represents a composite salt core.

Table 2 below illustrates an example of an expandable core, Core Type C1.

TABLE 2

| | Mineral | | Expandable |
|---|---|---|---|
| C1 | Salt | Binder | Microspheres |
| Weight Ratio of | 0.0% | 30.0% | 70.0% |
| Composition | | | |

A volume expansion rate of expandable microspheres may range from 7-20 times. Accordingly, the expandable microspheres may only fill 5-15% of the hollow container (e.g., the container 154) before hot pressing. After hot pressing, for example, the expandable core illustrated in Table 2 may become sticky and shaped. Prior to the hot pressing, the expandable core illustrated in Table 2 may be capable of force pressure injection.

Table 3 below illustrates an example of an expandable salt core, Core Type C2.

TABLE 3

| | Mineral | | Expandable |
|---|---|---|---|
| C2 | Salt | Binder | Microspheres |
| Weight Ratio of | 62.7% | 10.3% | 27.0% |
| Composition | | | |

For the expandable salt core illustrated in Table 3, after mixing of the salt, the binder, and the expandable microspheres, the core material mixture becomes a dry dough that is easy to knead, and filling the hollow container (e.g., the container 154) with this core material mixture may be easy. This dry dough mixture does not stick to the hollow container. After hot pressing, for example, the dry dough mixture expands violently but does not collapse.

Table 4 below illustrates a first example of a hard salt core, Core Type C3.

TABLE 4

| | Mineral | | Expandable |
|---|---|---|---|
| C3 | Salt | Binder | Microspheres |
| Weight Ratio of | 67.0% | 33.0% | 0.0% |
| Composition | | | |

For the hard salt core illustrated in Table 4, after mixing of the salt and the binder, the core material mixture may be close to wet dough that may be kneaded into a ball. This kneaded ball may stick to the hollow container (e.g., the container 154), but filling the hollow container with this core material mixture may be easy. The core material mixture may be shaped by the hollow container after hot pressing, for example.

Table 5 below illustrates a second example of a hard salt core, Core Type C3.

TABLE 5

| | Mineral | | Expandable |
|---|---|---|---|
| C3 | Salt | Binder | Microspheres |
| Weight Ratio of | 86.0% | 14.0% | 0.0% |
| Composition | | | |

For the hard salt core illustrated in Table 5, after mixing of the salt and the binder, the core material mixture becomes a dough with moderate dryness/wetness that is easy to knead, and filling the hollow container (e.g., the container 154) with this core material mixture may be easy. The kneaded dough mixture may not stick to the hollow container. The core material mixture may be easily shaped within the hollow container after hot pressing, for example. The compressive strength of the core may, for example, reach 21 MPa during hot pressing, and a dissolution time of a 25 g core, after hot pressing, may be 30-60 minutes.

Table 6 below illustrates an example of a composite salt core, Core Type C4.

TABLE 6

| | Mineral | | Expandable |
|---|---|---|---|
| C4 | Salt | Binder | Microspheres |
| Weight Ratio of | 83.3% | 16.7% | 0.1 g/cm² |
| Composition | | | |

For the composite salt core illustrated in Table 6, a hard salt core (e.g., as illustrated in Table 4 or Table 5) is covered with an expandable core (e.g., as illustrated in Table 2). After hot pressing, for example, the hard salt core is partially shaped, and the expandable core expands.

FIG. 6 shows a second embodiment of a material mixture 600 within a container 601 (e.g., the container 154). The material mixture 600 includes expandable beads 602 applied to an outer surface 604 of a salt mixture 606 (e.g., including salt and a binder). In other words, in act 402, instead of the binder being added to the salt mixture 504 including the salt and the expandable beads 502, as described above, the salt and the binder are mixed to form the salt mixture 606, and the expandable beads 602 are applied to such a mixture 600 (e.g., as part of the drying act in act 404). As an example, such a salt mixture 606 includes, before drying in act 404, 82.0% weight percentage salt and 18.0% weight percentage binder. Water may not be added to this mixture. Other weight percentages may be provided. For example, a salt mixture may include 75.0%-90.0% weight percentage salt and 10.0%-25% weight percentage binder.

Such a material mixture 600 includes, after the application of the expandable beads 602 and the drying in act 404, 89.3% weight percentage salt, 0.9% weight percentage expandable beads, and 9.8% weight percentage binder.

Other configurations may be provided. For example, Table 7 below illustrates an example of a hard salt core with reactive salts added.

TABLE 7

| | Mineral | | Expandable |
|---|---|---|---|
| | Salt | Binder | Microspheres |
| Weight Ratio of | 83.3% | 13.4% | 0.0% |
| Composition | | | |

For example, 3.3% reactive salts may be added to improve a dissolution rate. The compressive strength of the core is reduced, but the core may withstand the pressure of the hot pressing, for example. The compressive strength of the core is, for example, 3.96 MPA, and the dissolution time of a, for example, 25 g core may be one minute.

Reactive salts may trigger a rapid chemical reaction with mineral salts in water. Any number of different reactive salts including, for example, magnesium carbonate, sodium bicarbonate, sodium hydroxide, butanedioic acid, citric acid, malic acid, tartaric acid, another reactive salt, or any combination thereof may be included.

In act 406, layers of a layup pattern are positioned on the container filled with the salt mixture (e.g., the dried salt mixture) according to the design of the composite bicycle component to be manufactured. In other words, fabric sheets are laminated according to the design of the composite bicycle component to be manufactured.

For example, the layup pattern includes a first layup pattern on a first side of the container and a second layup pattern on a second side of the container. The layup pattern may correspond to the layup pattern shown in the example of FIG. 3, though other layup patterns for the same bicycle component or other bicycle components may be provided. The layup pattern may include more than the first layup pattern and the second layup pattern. For example, the layup pattern may include at least a third layup pattern and a fourth layup pattern at sides extending between the first side and the second side of the container, respectively. The number of layup patterns within an overall layup pattern may be determined, for example, by a shape of a cross-section of a hollow portion of the bicycle component to be manufactured.

The layup pattern may include, for example, first layers and second layers. Each of the first layers may include a number of sheets of a thermoplastic material. Each of the second layers may include a number of sheets (e.g., bendable fabric preform sheets) of a thermoplastic material with one or more reinforcing fiber materials. For example, the second layers may be a carbon fiber reinforced thermoplastic. The layup pattern may include more, fewer, and/or different types of layers. For example, the layup pattern may only include the sheets of thermoplastic material or only the sheets of the thermoplastic material with the one or more reinforcing fiber materials. As another example, the layup pattern may include the second layers including a number of sheets made of a thermoplastic material with a first reinforcing fiber material, and third layers including a number of sheets made of the thermoplastic material with a second reinforcing fiber material that is different than the first reinforcing fiber material. Other configurations may be provided.

In one embodiment, a first layer may be positioned on a first side of the container (e.g., within the first layup pattern), and a first layer may be positioned on a second side of the container (e.g., within the second layup pattern), where the second side of the container is opposite the first side of the container. A second layer may then be positioned on the first layer at the first side of the container (e.g., within the first layup pattern), and a second layer may be positioned on the first layer at the second side of the container (e.g., within the second layup pattern).

Additional, fewer, and/or different layers may be positioned. For example, another first layer may be positioned on the second layer at the first side of the container, and another second layer may be positioned on the other first layer at the first side of the container (e.g., within the first layup pattern). This pattern and/or another pattern may be repeated at the first side of the container, the second side of the container, and/or one or more other sides of the container any number of times. More, fewer, and/or different layers may be positioned at the second side of the container, for example, within the second layup pattern.

In act 408, the bicycle component (e.g., a composite laminate) may be formed. For example, the laminated fabric sheets positioned on the container in act 406 may be hot-pressed. Forming the composite laminate may include curing the composite laminate on the container and the salt core formed in act 404, for example. The composite laminate may be cured in any number of ways including, for example, by press curing, autoclave curing, or oven curing the composite laminate. Other types of curing may be used.

More than one type of expandable beads may be included within the salt mixture produced in act 402, such that more than two stages of internal pressure may be provided during, for example, the curing process of act 408. The thermoplastic resin shell container, for example, not only acts as a support for shaping the salt mixture into the core, but also serves as resin impregnation of an overall composite material of the component to be manufactured using the method 400.

In act 410, the salt and the binder of the salt mixture are dissolved. The salt and the binder are dissolved using any number of solutions including, for example, water. The manufactured component may be permeable, and the solution may reach the salt mixture for the dissolution of the salt and the binder. Alternatively or additionally, the manufactured component may include a port via which the solution is introduced into the hollow portion of the manufactured component for dissolving of the salt and the binder. In one embodiment, the expandable beads may also be washed away with the solution or another solution. The dissolving and washing away of the salt mixture leaves a hollow part including the container and the hot-pressed laminated fabric sheets.

In one embodiment, the dissolving of the salt and the binder of the salt mixture may be performed more quickly by, for example, increasing a temperature of the solution for the dissolving and/or the washing, applying ultrasonic vibration to the salt mixture, and/or increasing a scour force.

The method 400 may be used to manufacture any number of different bicycle components. For example, in addition to bicycle crank arms, the method 400 may be used to manufacture rims, handlebars, stems, seat posts, seat rails, shifting levers, brake levers, derailleur cages, suspension fork components, and/or other bicycle components.

The positioning of layers of a layup pattern (e.g., in act 406) on, for example, a container filled with a salt mixture may present issues based on, for example, the resin used. For example, with application of a thermoplastic resin, which does not have a sticky surface at room temperature, extra equipment (e.g., a double-belt press machine and a hot-press machine) may be used for tape consolidation and laminate production to obtain carbon fiber reinforced thermoplastic (CFRTP) sheets (e.g., the second layers 152) with specific stacking angles of thermoplastic prepregs.

As another example, with application of a thermosetting resin (e.g., an epoxy), which does have a sticky surface at room temperature, the lamination process requires personnel to lay out stacking angles of the thermosetting prepregs.

State of the art manufacturing of a composite component (e.g., the crank arm 140) may include a number of acts performed by expensive equipment. For example, the acts may include powder-coating with spread carbon fiber tows, a powder reservoir, an infrared heat source, and powder-coated tows. The acts may also include tape consolidation with a double-belt press, laminate production of a multi-ply laminate using, for example, a static hot-press machine, and thermoforming with another infrared heat source and a tool (e.g., a three-dimensional (3D) tool) for forming the composite component.

An attachment mechanism (e.g., an interlocking mechanism) of the present embodiments may set a layup pattern of layers (e.g., the first layers 150 and the second layers 152; a plurality of CFRTP prepregs) together for forming of, for example, a composite component (e.g., the crank arm 140). The interlocking mechanism may be included on outermost layers (e.g., outermost first layers 150) of the layup pattern and may be configured to set (e.g., lock) the layup pattern of layers together before, for example, the thermoforming. Use of the interlocking mechanism of the present embodiments when manufacturing the composite component, for example, may reduce required personnel for manufacturing and may reduce time and cost for manufacturing, in that acts of the state of the art manufacturing process (e.g., tape consolidation and laminate production) and the corresponding equipment (e.g., a double-belt press and a static hot-press machine) may not be used.

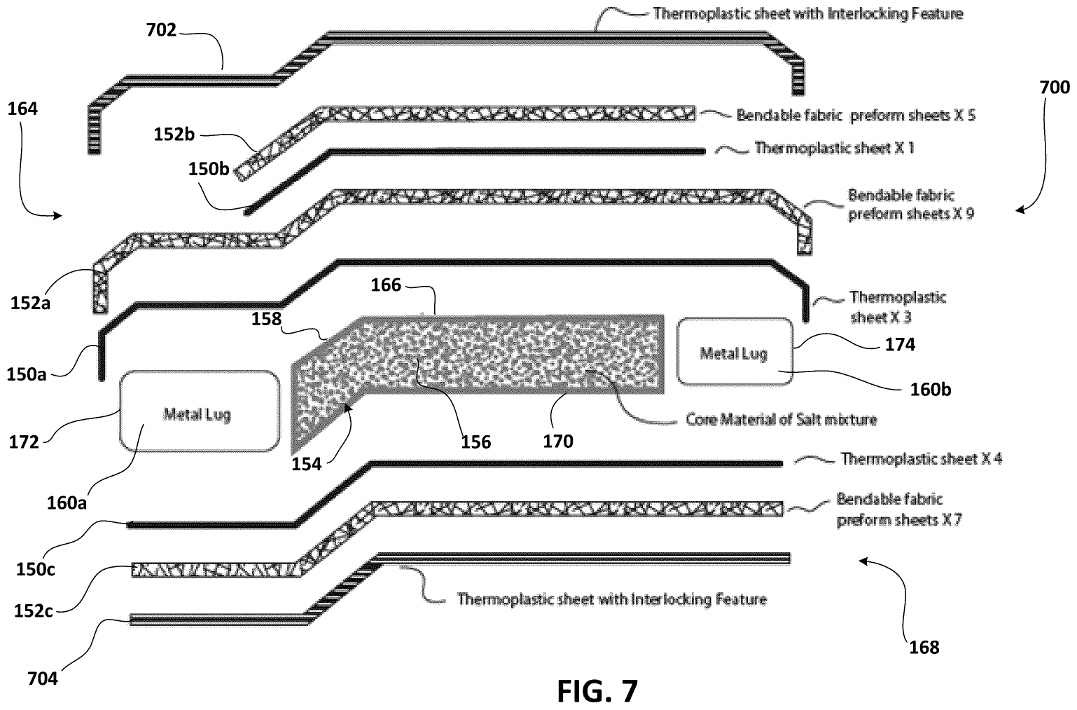

FIG. 7 illustrates a layup pattern 700 including the interlocking mechanism of the present embodiments. The layup pattern 700 is similar to the layup pattern of FIG. 3, though other layup patterns may be provided. The layup pattern 700 includes the container 154 (e.g., a thermoplastic sheet container) that houses the core material 156. The core material 156 may be any number of mixtures of materials including, for example, a salt mixture. Thermoplastic sheets 158 of the container 154, for example, are bendable/formable, such that a shape of the container 154 corresponds to a shape of the bicycle component (e.g., the crank arm 140) to be manufactured according to a design.

The layup pattern 700 includes the first layup pattern 164 on the first side 166 of the container 154 and the second layup pattern 168 on the second side 170 of the container 154. As with the layup pattern of FIG. 3, the first layup pattern 164 includes the first layer 150a (e.g., including three thermoplastic sheets) disposed on the container 154 and the metal lugs 160a, 160b, for example, the second layer 152a (e.g., including nine fabric preform sheets) disposed on the first layer 150a, the first layer 150b (e.g., including one thermoplastic sheet) disposed on the second layer 152a, and the second layer 152b (e.g., including five fabric preform sheets) disposed on the first layer 150b.

As with the layup pattern of FIG. 3, the second layup pattern 168 includes the first layer 150c (e.g., including four thermoplastic sheets) disposed on the second side 170 of the container 154 and the metal lugs 160a, 160b, for example, and the second layer 152c (e.g., including seven fabric preform sheets) disposed on the first layer 150c. The first layup pattern 164 and/or the second layup pattern 168 of the layup pattern 700 may include more, fewer, and/or different first layers 150, second layers 152, and/or other layers.

For example, as shown in FIG. 7, the layup first layup pattern 164 may include a first outermost layer 702, and the second layup pattern 168 may include a second outermost layer 704. The first outermost layer 702 and the second outermost layer 704 may be any number of shapes and/or sizes. For example, the first outermost layer 702 may be disposed on at least the second layer 152b and part of the second layer 152a, and shaped and sized to cover the first layer 150a, the second layer 152a, the first layer 150b, and the second layer 152b. In one embodiment, the first outermost layer 702 also covers the opposite ends 172, 174 of the metal lugs 160a, 160b, respectively. The second outermost layer 704 may be disposed on at least the second layer 152c, and shaped and sized to cover the first layer 150c and the second layer 152c.

The first outermost layer 702 and the second outermost layer 704 may be made of any number of materials. For example, the first outermost layer 702 and the second outermost layer 704 may be thermoplastic sheets (e.g., polypropylene or polycarbonate sheets). The first outermost layer 702 and the second outermost layer 704 may be made of a same material or different materials. Layup patterns (e.g., the layup pattern 700) may include more, fewer, and/or different outermost layers (e.g., different shapes, sizes, and/or made of different materials).

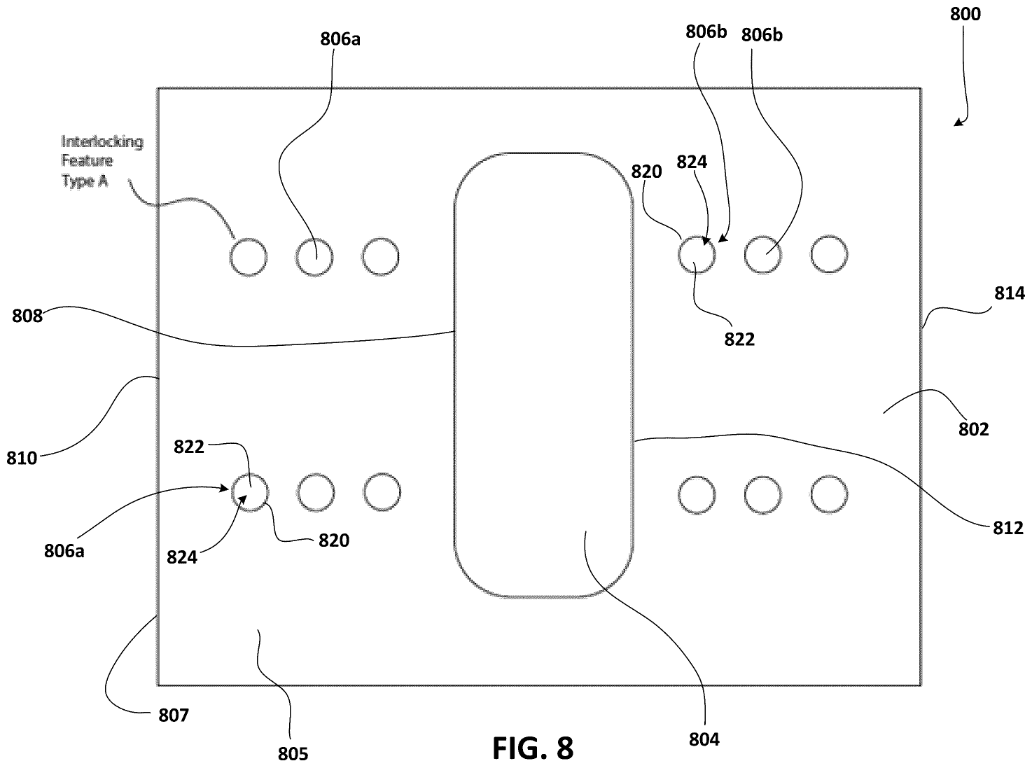

The first outermost layer 702 and the second outermost layer 704 include attachment features (e.g., interlocking features) that form the interlocking mechanism. FIG. 8 shows a top view of an example of an outermost layer 800 (e.g., a cover). The outermost layer 800 of FIG. 8 may be used for the first outermost layer 702, the second outermost layer 704, or both the first outermost layer 702 and the second outermost layer 704. The outermost layer 800 includes a base 802 (e.g., a base layer or sheet) that may be any number of different shapes and/or sizes. For example, the base 802 may be rectangular and may be sized based on a length, a width, and a height of the layup pattern 700. For example, a length of the base 802 may be equal to the width of the layup pattern 700 plus two times the height of the layup pattern 700, and the width of the base 802 may be approximately equal to the length of the layup pattern 700 (e.g., plus 20% or 30% of the length of the layup pattern 700). Other shapes and/or sizes of the base 802 of the outermost layer 800 may be provided.

The outermost layer 800 also includes a pocket 804 (e.g., a cavity) that is recessed in a direction perpendicular to a surface of the base 802 (e.g., in a direction into the page). For example, the base 802 of the outermost layer 800 may have a first surface 805 (e.g., a top surface) and a second surface 807 (e.g., a bottom surface) opposite the first surface 805. The pocket 804 may, for example, extend away from the second surface 807 (e.g., be recessed in a direction in which the second surface 807 faces).

The pocket 804 may be any number of sizes and shapes. For example, the pocket 804 is a rounded rectangle and is shaped such that the layup pattern 700 is positionable within the pocket 804. The height of the layup pattern 700 may be greater than a depth of the pocket 804, such that layup pattern 700 is not entirely disposable within the pocket 804. Other shapes and/or sizes of the pocket 804 may be provided.

The outermost layer 800 also includes a plurality of interlocking features 806. For example, the outermost layer 800 includes one or more interlocking features 806a disposed between a first side 808 of the pocket 804 and a first side 810 of the base 802, and one or more interlocking features 806b disposed between a second side 812 of the pocket 804 and a second side 814 of the base 802. The first side 808 of the pocket 804 is opposite the second side 812 of the pocket 804, and the first side 810 of the base 802 is opposite the second side 814 of the base 802.

The outermost layer 800 may include any number of interlocking features 806. For example, as shown in FIG. 8, the outermost layer 800 may include six interlocking features 806a between the first side 808 of the pocket 804 and the first side 810 of the base, and six interlocking features 806b between the second side 812 of the pocket 804 and the second side 814 of the base 802 of the outermost layer 800. The six interlocking features 806a may be positioned, such that two rows of the interlocking features 806a, each with three uniformly spaced interlocking features 806a, are formed. The six interlocking features 806b may be positioned, such that two rows of the interlocking features 806b, each with three uniformly spaced interlocking features 806b, are formed. Other configurations may be provided. For example, the outermost layer 800 may include more or fewer interlocking features 806, the interlocking features 806a and/or the interlocking features 806b may be positioned in more or fewer rows, and/or the interlocking features 806a and/or the interlocking features 806b may be variably spaced relative to each other (e.g., within respective rows).

The interlocking features 806 (e.g., extended structures) extend away from the first surface 805 (e.g., the top surface) or the second surface 807 (e.g., the bottom surface) of the base 802 of the outermost layer 800. For example, the outermost layer 800 of FIG. 8 may be used for the first outermost layer 702 of FIG. 7, and the interlocking features 806 may extend away from the first surface 805 of the base 802 of the outermost layer 800 (e.g., in a direction out of the page of FIG. 8).

Each of the interlocking features 806 includes one or more walls 820 (e.g., one wall forming a hollow cylinder) that extend away from, for example, the first surface 805 of the base 802 of the outermost layer 800, and a recessed wall 822 (e.g., relative to the first surface 805 of the base 802 of the outermost layer 800). The one or more walls 820 extending away from the first surface 805 of the base 802 of the outermost layer 800 and the recessed wall 822 form a pocket or cavity 824 (e.g., cavities). The cavities 824 and the pocket 804 are accessible at different surfaces of the first surface 805 and the second surface 807 of the base 802 of the outermost layer 800, respectively. For example, the pocket 804 may be accessible at the first surface 805, and the cavities 824 may be accessible at the second surface 807. In one embodiment, at least some of the cavities 824 (e.g., all of the cavities) and the pocket 804 are accessible at a same surface (e.g., the first surface 805 of the base 802 of the outermost layer 800).

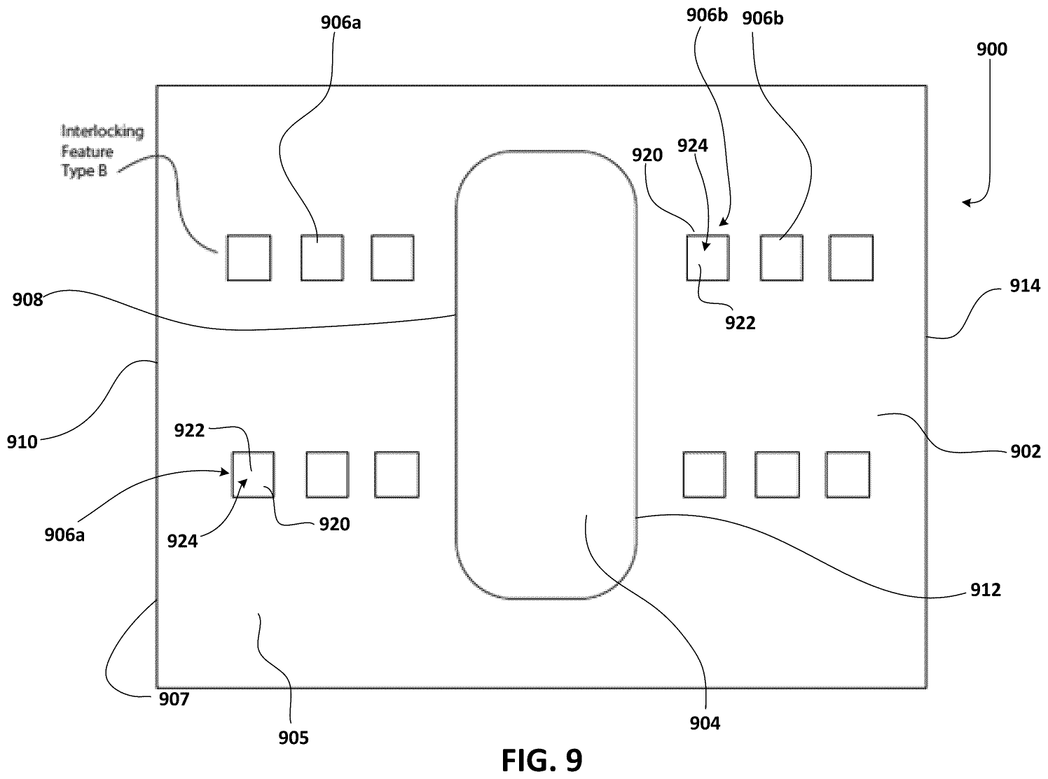

The interlocking features 806 may be any number of shapes. For example, the shape of an interlocking feature 806 may be defined by at least the one or more walls 820 extending away from the first surface 805 of the base 802 of the outermost layer 800. In the example shown in FIG. 8, each of the interlocking features 806 includes one wall 820 that forms a hollow cylinder. In other words, a cross section through the cavity 824 formed by the one wall 820 is circular. In other embodiments, the interlocking features 806 may be shaped differently. For example, each of the interlocking features 806 may be formed by more walls 820 (e.g., three or more walls 820), such that differently shaped cavities 824 are provided. For example, at least one of the interlocking features 806 may include four walls 820 (see FIG. 9), such that a hollow cuboid is formed (e.g., with a square-shaped cross-section through the cavity 824). In one embodiment, all of the interlocking features 806 are a same shape. In another embodiment, the interlocking features 806 include interlocking features of at least two different shapes (e.g., the interlocking features 806a are hollow cylinders, and the interlocking features 806b are hollow cuboids).

The interlocking features 806 may be any number of sizes. The interlocking features 806 may all be a same size, or the interlocking features 806 may include interlocking features having two or more different sizes (e.g., the interlocking features 806a may be a different size than the interlocking features 806b). In one embodiment, the interlocking features 806 are sized based on (e.g., size corresponds to) a size of interlocking features of another outermost layer. FIG. 9 illustrates an example of, for example, the other outermost layer.

FIG. 9 shows a top view of another example of an outermost layer 900. The outermost layer 900 of FIG. 9 may be used for the first outermost layer 702, the second outermost layer 704, or both the first outermost layer 702 and the second outermost layer 704. In the example in which the outermost layer 800 is used for the first outermost layer 702, the outermost layer 900 may be used for the second outermost layer 704. The outermost layer 900 includes a base 902 (e.g., a base layer or sheet) that may be any number of different shapes and/or sizes. For example, the base 902, like the base 802 of the outermost layer 800 of FIG. 8, may be rectangular and may be sized based on a length, a width, and a height of the layup pattern 700. For example, a length of the base 902 may be equal to the width of the layup pattern 700 plus two times the height of the layup pattern 700, and the width of the base 902 may be approximately equal to the length of the layup pattern 700 (e.g., plus 20% or 30% of the length of the layup pattern 700). Other shapes and/or sizes of the base 902 of the outermost layer 900 may be provided.

The outermost layer 900 also includes a pocket 904 (e.g., a cavity) that is recessed in a direction perpendicular to a surface of the base 902 (e.g., in a direction into the page). For example, the base 902 of the outermost layer 900 may have a first surface 905 (e.g., a top surface) and a second surface 907 (e.g., a bottom surface) opposite the first surface 905. The pocket 904 may, for example, extend away from the second surface 907 (e.g., be recessed in a direction in which the second surface 907 faces).

The pocket 904 may be any number of sizes and shapes. For example, the pocket 904 is a rounded rectangle and is shaped such that part of the layup pattern 700 is positionable within the pocket 904. The height of the layup pattern 700 may be greater than a depth of the pocket 904, such that layup pattern 700 is not entirely disposable within the pocket 904. Other shapes and/or sizes of the pocket 904 may be provided.

The outermost layer 900 also includes a plurality of interlocking features 906. For example, the outermost layer 900 includes one or more interlocking features 906a disposed between a first side 908 of the pocket 904 and a first side 910 of the base 902, and one or more interlocking features 906b disposed between a second side 912 of the pocket 904 and a second side 914 of the base 902. The first side 908 of the pocket 904 is opposite the second side 912 of the pocket 904, and the first side 910 of the base 902 is opposite the second side 914 of the base 902.

The outermost layer 900 may include any number of interlocking features 906. For example, as shown in FIG. 9, the outermost layer 900 may include six interlocking features 906a between the first side 908 of the pocket 904 and the first side 910 of the base 902, and six interlocking features 906b between the second side 912 of the pocket 904 and the second side 914 of the base 902 of the outermost layer 900. The six interlocking features 906a may be positioned, such that two rows of interlocking features 906a, each with three uniformly spaced interlocking features 906a, are formed. The six interlocking features 906b may be positioned, such that two rows of interlocking features 906b, each with three uniformly spaced interlocking features 906b, are formed. Other configurations may be provided. For example, the outermost layer 900 may include more or fewer interlocking features 906, the interlocking features 906a and/or the interlocking features 906b may be positioned in more or fewer rows, and/or the interlocking features 906a and/or the interlocking features 906b may be variably spaced relative to each other (e.g., within respective rows).

The interlocking features 906 (e.g., extended structures) extend away from the first surface 905 (e.g., the top surface) or the second surface 907 (e.g., the bottom surface) of the base 902 of the outermost layer 900. For example, the outermost layer 900 of FIG. 9 may be used for the second outermost layer 704 of FIG. 7, and the interlocking features 906 may extend away from the first surface 905 of the base 902 of the outermost layer 900 (e.g., in a direction out of the page of FIG. 9).

Each of the interlocking features 906 includes one or more walls 920 (e.g., four walls forming a hollow cuboid) that extend away from, for example, the first surface 905 of the base 902 of the outermost layer 900, and a recessed wall 922 (e.g., relative to the first surface 905 of the base 902 of the outermost layer 900; parallel with the first surface 905 of the base 902 of the outermost layer 900). The one or more walls 920 extending away from the first surface 905 of the base 902 of the outermost layer 900 and the recessed wall 922 form a pocket or cavity 924 (e.g., a cavity). The cavities 924 and the pocket 904 are accessible at different surfaces of the first surface 905 and the second surface 907 of the base 902 of the outermost layer 900, respectively. For example, the pocket 904 may be accessible at the first surface 905, and the cavities 924 may be accessible at the second surface 907. In one embodiment, at least some of the cavities 924 (e.g., all of the cavities) and the pocket 904 are accessible at a same surface (e.g., the first surface 905 of the base 902 of the outermost layer 900).

The interlocking features 906 may be any number of shapes. For example, the shape of an interlocking feature 906 may be defined by at least the one or more walls 920 extending away from the first surface 905 of the base 902 of the outermost layer 900. In the example shown in FIG. 9, each of the interlocking features 906 includes four walls 920 that form a hollow cuboid. In other words, a cross section through the cavity 924 formed by the four walls 920 is a square. In other embodiments, the interlocking features 906 may be shaped differently. For example, each of the interlocking features 906 may be formed by more or fewer walls 920 (e.g., three or fewer walls 920), such that differently shaped cavities 924 are provided. For example, at least one of the interlocking features 906 may include one wall 920 (see FIG. 8), such that a hollow cylinder is formed (e.g., with a circular cross-section through the cavity 924). In one embodiment, all of the interlocking features 906 are a same shape. In another embodiment, the interlocking features 906 include interlocking features of at least two different shapes (e.g., the interlocking features 906a are hollow cuboids, and the interlocking features 906b are hollow cylinders).

The interlocking features 906 may be any number of sizes. The interlocking features 906 may all be a same size, or the interlocking features 906 may include interlocking features having two or more different sizes (e.g., the interlocking features 906a may be a different size than the interlocking features 906b). In one embodiment, the interlocking features 906 are sized based on (e.g., to correspond to) a size of interlocking features of another outermost layer. For example, a length of a side of the square cross-section through the cavity 924 of a respective interlocking feature 906 may be the same as size as a diameter of the circular cross-section through the cavity 824 of a respective interlocking feature 806. Other sizes may be provided.

Referring to FIG. 7, assuming, for example, the first outermost layer 702 is formed by the outermost layer 800 of FIG. 8 and the second outermost layer 704 is formed by the outermost layer 900 of FIG. 9, the layup pattern 700 is positioned within the pocket 904 of the outermost layer 900, such that the outermost layer 900 may cover at least the second layer 152c of the layup pattern 700 (e.g., and may cover additional layers of the layup pattern 700). The outermost layer 800 is positioned on the layup pattern 700, such that the layup pattern 700 is also positioned within the pocket 804 of the outermost layer 800. For example, the outermost layer 800 may cover at least the second layer 152b (e.g., and may cover additional layers of the layup pattern 700).

The first side 910 and the second side 914 of the base 902 of the outermost layer 900 are pivoted (e.g., upwards) towards the layup pattern 700 disposed within the pocket 904 of the outermost layer 900. The first side 910 and the second side 914 of the base 902 of the outermost layer 900 may be pivoted towards the layup pattern 700 until the base 902 of the outermost layer 900 is in contact with opposite sides of the layup pattern 700, respectively.

The first side 810 and the second side 814 of the base 802 of the outermost layer 800 are pivoted (e.g., downwards) towards the layup pattern 700 disposed within the pocket 804 of the outermost layer 800. The first side 810 and the second side 814 of the base 802 of the outermost layer 800 may be pivoted towards the layup pattern 700 until the outermost layer 800 comes into contact with the outermost layer 900. In one embodiment, movement of the outermost layer 800 and the outermost layer 900 is switched. For example, the first side 810 and the second side 814 of the outermost layer 800 may be pivoted (e.g., downwards) towards opposite sides of the layup pattern 700, respectively, and the first side 910 and the second side 914 of the outermost layer 900 may be pivoted (e.g., upwards) towards the layup pattern 700 until the outermost layer 900 comes into contact with the outermost layer 800.

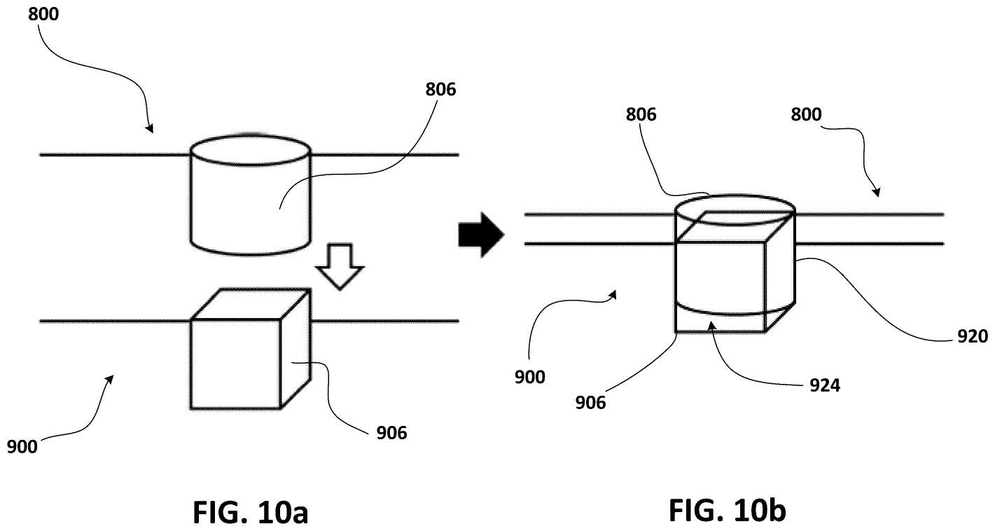

FIGS. 10a and 10b respectively illustrate before and after engagement of one of the interlocking features 806 of the outermost layer 800 with one of the interlocking features 900 of the outermost layer 900. Referring to FIG. 10b, the one interlocking feature 806 of the outermost layer 800 is disposed within the cavity 924 defined by the walls 920 of the one interlocking feature 906 of the outermost layer 900.

Referring to FIGS. 8 and 9, for example, the six interlocking features 806a disposed between the first side 808 of the pocket 804 and the first side 810 of the base 802 engage with the six interlocking features 906a disposed between the first side 908 of the pocket 904 and the first side 910 of the base 902, respectively, and the six interlocking features 806b disposed between the second side 812 of the pocket 804 and the second side 814 of the base 802 engage with the six interlocking features 906b disposed between the second side 912 of the pocket 904 and the second side 914 of the base 902. The interlocking features 806a, 806b may be positioned within (e.g., with a friction fit relative to) the cavities 924 of the interlocking features 906a, 906b, respectively, such that layers of the layup pattern 700, for example, are set and the layers of the layup pattern 700 are pressed towards the container 154.

Other configurations may be provided. For example, the outermost layer 800 may include square-shaped interlocking features 806, and the outermost layer 900 may include circular-shaped interlocking features 906. The circular-shaped interlocking features 906 of the outermost layer 900 may be positioned within (e.g., with a friction fit relative to) the square-shaped interlocking features 806 of the outermost layer 800.

As another example, portions of the base 802 of the outermost layer 800 may be removed (e.g., cut away), such that strips including rows of interlocking features 806a, 806b (e.g., four rows of three interlocking features 806a, 806b) and extending away from the pocket 804 are provided. Such strips allow individual rows of interlocking features 806a, 806b to be pivoted relative to the pocket 804 independently of each other. The same configuration may be provided for the base 902 of the outermost layer 900.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. An intermediate product for a bicycle, the intermediate product comprising:
a composite laminate comprising:
a hollow container made of a first polymer-based material;
a layer of a second polymer-based material disposed on the hollow container; and
a layer of a composite material disposed on the layer of the second polymer-based material; and
a water soluble core material disposed within the hollow container,
wherein the water soluble core material is dissolvable and removable from the composite laminate after lamination of the composite laminate.

2. The intermediate product of claim 1, wherein the intermediate product includes a crank arm.

3. The intermediate product of claim 1, wherein the second polymer-based material is the same as the first polymer-based material, and
wherein the first polymer-based material and the second polymer-based material are a thermoplastic material.

4. The intermediate product of claim 1, wherein the composite material includes a matrix of a third polymer-based material and fibers of a reinforcing material, and
wherein the third polymer-based material is a thermoplastic, a thermoset matrix, or a combination thereof, and the fibers of the reinforcing material are carbon fibers.

5. The intermediate product of claim 1, further comprising a preformed connector disposed on the hollow container,
wherein the layer of the second polymer-based material and the layer of the composite material are disposed on the preformed connector, such that the preformed connector is integrated within the composite laminate.

6. The intermediate product of claim 1, wherein the water soluble core comprises salt, expandable microspheres, or salt and expandable microspheres.

7. The intermediate product of claim 6, wherein the water soluble core further comprises a binder.

8. The intermediate product of claim 7, wherein the salt comprises sodium chloride, potassium chloride, potassium sulfate, or any combination thereof, and
wherein the binder comprises gum Arabic, ethyl cellulose, sodium silicate, trehalose, starch, polyvinylpyrrolidone, polyethylene glycol, acrylamide, or any combination thereof.

9. The intermediate product of claim 1, wherein the hollow container has a first side and a second side opposite the first side,
wherein the layer of the second polymer-based material is a first layer of the second polymer-based material, and the layer of the composite material is a first layer of the composite material,
wherein the first layer of the second polymer-based material is disposed on the first side of the hollow container, and
wherein the composite laminate further comprises:
a second layer of the second polymer-based material disposed on the second side of the hollow container; and
a second layer of the composite material disposed on the second layer of the second polymer-based material.

10. A hollow bicycle component comprising:
a composite laminate comprising:
a hollow container made of a first polymer-based material;
a layer of a second polymer-based material disposed on the hollow container; and
a layer of a composite material disposed on the layer of the second polymer-based material, the composite material including a matrix of a third polymer-based material and fibers of a reinforcing material.

11. The hollow bicycle component of claim 10, wherein the composite laminate further comprises;
a first outermost layer configured as a first cover, the first outermost layer being made of a thermoplastic material and being configured to cover at least part of the composite laminate at a first side of the hollow container; and
a second outermost layer configured as a second cover, the second outermost layer being made of the thermoplastic material and being configured to cover at least a part of the composite laminate at a second side of the hollow container, the second side of the hollow container being opposite the first side of the hollow container.

12. The hollow bicycle component of claim 11, wherein the first outermost layer includes at least one first attachment feature, and the second outermost layer includes at least one second attachment feature,
wherein the at least one second attachment feature is attachable to the at least one first attachment feature before lamination of the composite laminate, such that the first layer of the second polymer-based material is pressed against the first side of the hollow container and the second layer of the second polymer-based material is pressed against the second side of the hollow container before the lamination.

13. The hollow bicycle component of claim 10, further comprising:
a connector disposed on the hollow container,
wherein the layer of the second polymer-based material and the layer of the composite material are disposed on the connector, such that the connector is integrated within the composite laminate.

14. The hollow bicycle component of claim 13, wherein the hollow container has a first side and a second side opposite the first side,
wherein the layer of the second polymer-based material is a first layer of the second polymer-based material, and the layer of the composite material is a first layer of the composite material,
wherein the first layer of the second polymer-based material is disposed on the first side of the hollow container, and
wherein the composite laminate further comprises:
a second layer of the second polymer-based material disposed on the second side of the hollow container; and
a second layer of the composite material disposed on the second layer of the second polymer-based material.

15. The hollow bicycle component of claim 14, wherein the hollow container has a first end and a second end opposite the first end, the first end and the second end extending between the first side and the second side of the hollow container,
wherein the connector is a first connector disposed on the first end of the hollow container,
wherein the second layer of the second polymer-based material and the second layer of the composite material are disposed on the connector,
wherein the hollow bicycle component further comprises a second connector disposed on the second end of the container, and
wherein the first layer of the second polymer-based material, the first layer of the composite material, the second layer of the second polymer-based material, and the second layer of the composite material are disposed on the second connector, such that the second connector is integrated within the composite laminate.

16. A method for manufacturing a hollow bicycle component, the method comprising:
forming a hollow container, the hollow container being made of a first polymer-based material;
preparing a core material mixture, the core material mixture including a salt, expandable microspheres, or a combination thereof;
filling the hollow container with the core material mixture;
forming a layup pattern, forming the layup pattern comprising positioning at least a layer of a second polymer-based material and a layer of a composite material on the hollow container;
forming a composite laminate including the hollow container, the layer of the second polymer-based material, and the layer of the composite material; and
dissolving, removing, or dissolving and removing the core material mixture.

17. The method of claim 16, wherein preparing the core material mixture comprises:
preparing a powdered mixture and stirring a binder into the powdered mixture, wherein preparing the powdered mixture comprises mixing the salt and the expandable microspheres; or
preparing a salt core and disposing the expandable microspheres on the salt core, wherein preparing the salt core comprises mixing the binder and the salt.

18. The method of claim 16, further comprising positioning a metal connector, such that the metal connector is in contact with the hollow container,
wherein the layer of the second polymer-based material and the layer of the composite material are positioned on the hollow container, such that the layer of the second polymer-based material and the layer of the composite material are also positioned on the metal connector, and
wherein forming the composite laminate comprises forming the composite laminate, such that the metal connector is integrated with the composite laminate.

19. The method of claim 16, wherein the hollow container has a first side and a second side opposite the first side,
where positioning at least the layer of the second polymer-based material and the layer of the composite material comprises:
positioning a first outermost layer at the first side of the hollow container, such that a first part of the layup pattern is disposed within a pocket of the first outermost layer; and
positioning a second outermost layer at the second side of the hollow container, such that a second part of the layup pattern is disposed within a pocket of the second outermost layer, and
wherein the method further comprises attaching the first outermost layer to the second outermost layer, the attaching comprising attaching an attaching feature of the first outermost layer to an attaching feature of the second outermost layer.

20. The method of claim 16, wherein forming the composite laminate comprises hot pressing the composite laminate.
